(19) United States
(12) Patent Application Publication
(10) Pub. No.: US 2006/0292352 A1
(43) Pub. Date: Dec. 28, 2006

(54) Optical film assembly and manufacturing method and manufacturing apparatus for producing the same

(75) Inventor: Chi-Chen Cheng, Chang Hua Hsien (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/473,264

(22) Filed: Jun. 23, 2006

(30) Foreign Application Priority Data
Jun. 24, 2005 (TW) 94121267

(51) Int. Cl. B32B 23/02

(52) U.S. Cl. 428/192

(57) ABSTRACT

An optical film assembly comprises a plurality of optical films and a merging region. The optical films can be chosen arbitrarily and are superposed layer by layer. The merging region is formed by hot pressingand merging the optical films together so as to integrate them into an optical film assembly which is advantageous to the fabrication process of the backlight module. Also, a method and an apparatus for manufacturing the optical film assembly are also provided to produce the optical film assembly.

### BACKGROUND OF THE INVENTION

1. Field of the Invention

2. Description of the Prior Art

Among the image displaying apparatuses, a liquid crystal display (LCD) has the following advantages: light weight, small volume, lower power consumption, and no radiation, and that is why it can be applied widely to various equipments.

The LCD can be mainly divided into two parts. The first part is a backlight module for providing stable and even light. The second part is a liquid crystal panel having two substrates and a liquid crystal layer hold between the substrates. The liquid crystal panel is located in the light projectile place of the backlight module. By controlling the orientation of liquid crystal molecules to change the ways of light in the liquid crystal panel, the diverse regions in the liquid crystal panel can show various brightness or colors to achieve versatile image displaying. For the light of the liquid crystal panel is adopted from the backlight module, so the features of the LCD such as brightness, even intensity, contrast, and available visual angle . . . etc would be greatly affected by the backlight module.

Therefore, in order to make the light of backlight module diffuse evenly, the backlight module adapts and cooperates multilayer optical films including the diffusion sheets and the prism sheets to produce a better light distribution and heighten the quality display.

Please refer to FIG. 1, an exploded view of a typical backlight module. As shown, the backlight module comprises a reflector 10, a frame 11, a light guide plate 12, a plurality of optical films 13, and a light source (not shown in the figure) disposed relevantly according to the light projecting ways.

The combination of the frame 11 and the reflector 10 form a box shape to bear the light guide plate l2, a plurality of the optical films 13, and other components of the backlight module.

The light guide plate 12 is disposed inside of the frame 11 on the top of the reflector 10. The light source (not shown here) can be disposed in a lateral side or a bottom side of the light guide plate 12. Light of the light source projects onto the light guide plate 12 and can be guided by the light guide plate 12. A lower portion of light can also be transmitted onto the light guide plate 12 by the reflecting of the reflector 10.

Each of the optical films 13 can be selected as different types depending on the demand of designs. For example, as shown in FIG. 1, the optical films 13 comprise a diffusion sheet 131, a first prism sheet 132, and a second prism sheet 133.

The diffusion sheet 131 is disposed above the light guide plate 12 so that the light projected from the light guide plate 12 can be diffused evenly by the diffusion sheet 131.

The first prism sheet 132 is disposed above the diffusion sheet 131. By utilizing an injection molding process or sticking an acrylic resin on the first prism sheet 132, the first prism sheet 132 can have a saw-toothed surface that can re-concentrate the light which has already proliferated so as to reduce the loss of light and increase the brightness of the backlight module.

The second prism sheet 133 is disposed above the first prism sheet 132 to present a function similar to that of the first prism sheet 132. The focusing direction of the second prism sheet 133 is perpendicular and interlaced with the focusing direction of the first prism sheet 132.

The above-mentioned optical films can help backlight module to provide a brighter light.

In the process of assembling the backlight module, the frame 11 and the reflector 10 are assembled together first, and then the light guide plate 12 and the light source are put in. After that, the optical films 13 is layered onto the light guide plate 12 or into the frame 11 one by one. If any errors happens in the assembly process, the optical films 13 would become warped or have interference patterns that highly degrade the quality of image displaying.

Furthermore, if any of the optical films 13 has different properties on opposing sides. It is quite possible to disposed them with wrong facing without consciousness.

Therefore, the process of assembling the backlight module needs a lot of labor and time, and so is low efficiency.

Besides, each aforesaid optical film 13 needs to be cut for many times so as to get the needful size. Such a manufacturing mode may also increase the cost in time and labor.

Therefore, how to increase the efficiency of assembling the optical films and lower the cost in manufacturing are objects for people whom are familiar with this art to dedicate.

### SUMMARY OF THE INVENTION

One object of the present invention is to provide an optical film assembly which is made up by plurality of optical films to reduce assembly procedures.

A further object of the present invention is also to provide a manufacturing method for the present optical film which just needs to be cut for once, and thereby the optical film assembly composed of numerous optical films from a reduced assembly scheme can be obtained.

One more object of the present invention is to provide a manufacturing apparatus for the present optical film.

The optical film assembly in accordance with the present invention includes a plurality of optical films and a merging region. Each of the optical films is superposed layer by layer and the merging region is formed by hot pressing the optical films.

The present invention also discloses a manufacturing method of manufacturing the optical film assembly. The method includes the following steps:
Superposing a plurality of optical films;
Hot pressing part of the optical films so as to make the optical films adhered to each other; and
Cutting the optical films

The present invention also discloses an apparatus which can adapt to partially adhere a first optical film to a second optical film. The apparatus includes a cutting platform, a first roller, a second roller, and a thermal cutter.

The cutting platform can be an arbitrary platform which is used to bear weight while in cutting the first optical film and the second optical film

The first roller can transmit the first optical film along a first path who passes through the cutting platform.

The second roller can transmit the second optical film along a second path who passes through the cutting platform and overlaps the first path.

The thermal cutter, located above the cutting platform, can move vertically for cutting the first optical film and the second optical film to a predetermined shape.

Therefore, while in cutting the first optical film and the second optical film, this thermal cutter can heat and bond the cut optical films simultaneously.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows an exploded view of a typical backlight module;

FIG. 2 shows a perspective view of an embodiment of an optical film assembly according to the present invention;

FIG. 3 shows an exploded view of a backlight module where the optical film assembly is applied in according to the present invention;

FIG. 4 shows a flow chart of an embodiment of the manufacturing method according to the present invention; and

FIG. 5 shows a perspective view of an embodiment of the manufacturing apparatus according to the present invention.

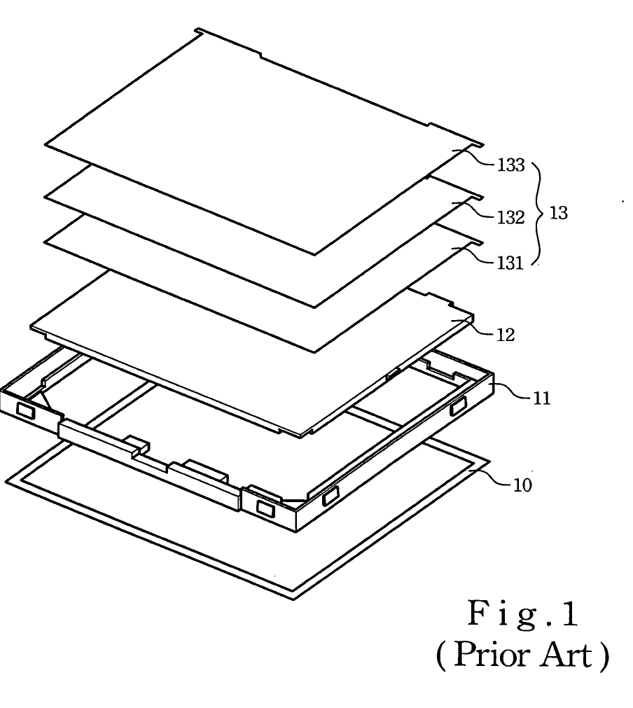

### DESCRIPTION OF THE PREFERRED EMBODIMENTS

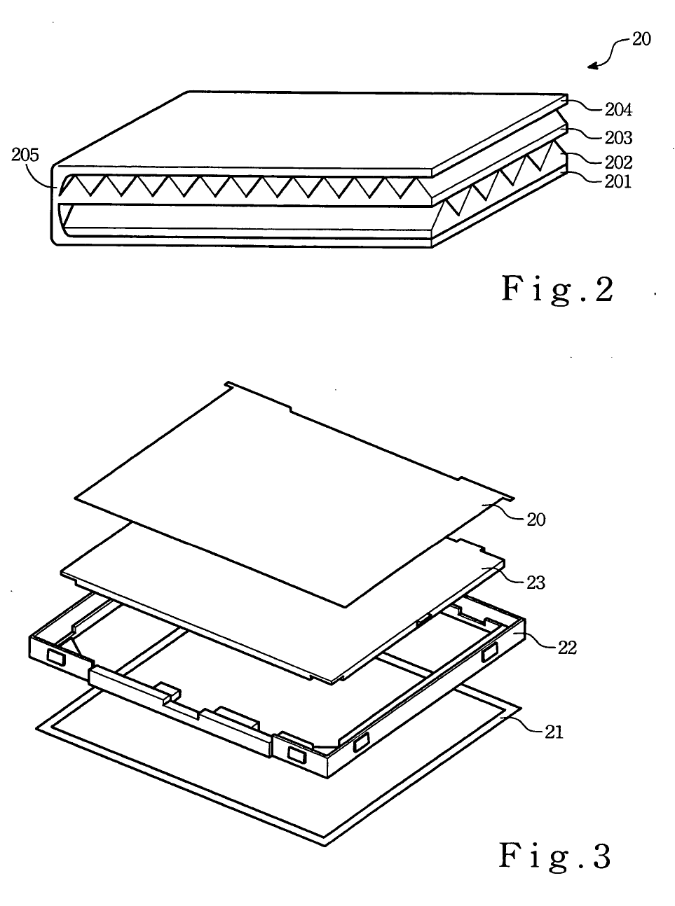

Please refer to FIG. 2, a perspective view of an embodiment of an optical film assembly 20 according to the present invention. As shown in FIG. 2, the optical film assembly 20 can include a plurality of optical films similar to that described in the background section.

The optical films of the present invention can be any type. For example, the optical films can be selected from the group consisting of diffusion sheet and brightness enhancement film (such as prism sheet). In this embodiment, as shown in FIG. 2, the optical films include a lower diffusion sheet 201, a first prism sheet 202, a second prism 203, and an upper diffusion sheet 204. Besides, each of the optical films is superposed layer by layer.

The first prism sheet 202 is superposed above the lower diffusion sheet 201. The first prism sheet 202 has a saw-toothed surface that makes the proliferated light re-concentrated again so as to reduce the loss of light and increase the brightness of the backlight module.

The second prism sheet 203 is superposed above the first prism sheet 202 and has a function similar to that of the first prism sheet 202. The focusing direction of the second prism sheet 203 is perpendicular to and interlaced with the focusing direction of the first prism sheet 202.

The upper diffusion sheet 204 is superposed above the second prism sheet 203. The light projected from the second prism sheet 203 can be diffused evenly by the upper diffusion sheet 204 .

Besides, the optical film assembly according to the present invention further includes a merging region 205. The merging region is formed by heating, pressing, or hot pressing the optical films so as to make the optical films adhered to each other. Thus, the optical films 201,202,203,204 can be integrated into an independent optical film assembly 20 and thus can be fabricated in a backlight module directly non-like the prior art which needs to be assembled one by one and therefore spends a lot of labor and time. Above description means that the adjacent optical films 201,202,203,204 can be adhered temporarily or permanently after heating, pressing, or hot pressing the optical films 201,202,203,204 so as to fix the relative positions of the optical films 201,202,203,204 temporarily or permanently. In a preferred embodiment, the optical films 201,202,203,204 are heated up around the Glass Transition Temperature so as to have stickiness on a plurality of surfaces of the optical films 201,202,203,204 for making the adjacent optical films 201,202,203,204 adhered each other temporarily or permanently.

It should be noticed that the location and the shape of the merging region 205 can be varied depending on the demands of the designs.

For example, the merging region 205 can locate in comer of the optical film assembly 20. In another word, the optical films of the optical film assembly 20 are hot pressed only in their respective corners. Moreover, the merging region 205 also can locate at an edge of the optical film assembly 20. Similarly, the merging region 205 also can locate at the periphery of the optical film assembly 20. In addition, the merging region 205 can comprise a-line or a dot or any other shapes.

Please refer to FIG. 3, an exploded view of a backlight module where the optical film assembly 20 is applied in according to the present invention . As shown, the backlight module includes a reflector 21, a frame 22, a light guide plate 23, an optical film assembly 20, and a light source (not shown in the figure) which is properly disposed according to the light projecting ways.

The combination of the frame 22 and the reflector 21 form as a box shape which can bear the light guide plate 23, the optical film assembly 20, and other components of the backlight module.

The light guide plate 23 is disposed inside of the frame 22, on top of the reflector 21, and a light source (not shown) can be disposed in its lateral side or bottom side. Light of the light source projecting onto the light guide plate 23 can be guided by the light guide plate 23. A bottom part of light can be transmitted onto the light guide plate 23 again by the reflecting of the reflector 21.

The optical film assembly 20 can be fabricated in the backlight module directly on top of the light guide plate 23 so as to reduce the consuming of manpower and working-hours in assembling.

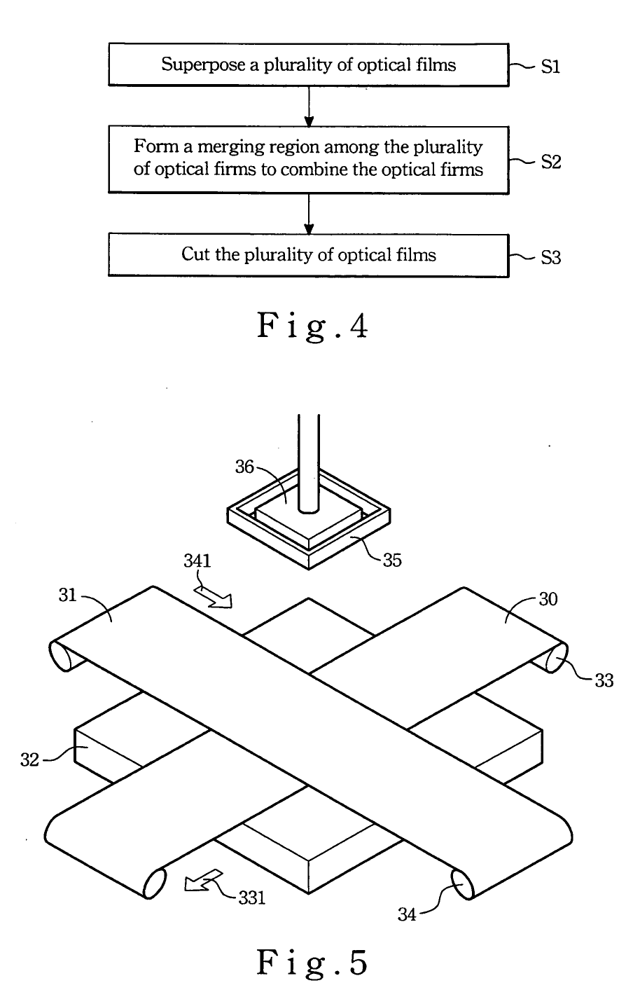

The present invention also discloses a manufacturing method for manufacturing the optical film assembly 20 shown in FIG. 2. Please refer to FIG. 4 which shows a flow chart of an embodiment of the manufacturing method according to the present invention. The manufacturing method includes the following steps:

S1: Superpose a plurality of optical films. These optical films are selected from the group consisting of diffusion sheet and brightness enhancement film (such as prism sheet). They are layer-wise superposed in order according to respective property of the optical films.

S2: Hot press part of the optical films so as to make the optical films adhered to each other. In this step, to heat and thus soften a predetermined area of the optical films is carried out so as to make the predetermined area of the optical films hot press and adhered mutually to form a hot pressed part of the optical films. The way of heating and hot pressing the predetermined areas of the optical films directly can avoid using various types of glue or fixing agents so as to prevent from the residual materials sticking on the optical films that would definitely affect the quality of the optical films.

S3: Cut the optical films.

In a preferred embodiment, the steps of hot pressing and cutting the optical films are performed simultaneously so as to reduce the manufacturing procedures. In another word, to heat the predetermined area of these optical films can be performed simultaneously with the cutting.

Further, the step of hot pressing the predetermined area of the optical films to form a hot pressed part of the optical films can be performed by cutting the optical films, such as heat cutting or laser cutting. Taking the heat cutting for an example, a cutting tool is provided with enough temperature to hot press and adhere the optical films, so that the optical films can be cut and hot press to form a hot pressed part of the optical films simultaneously

While in cutting these optical films to a needful size, the predetermined areas of these optical films are hot pressed and a hot pressed part of the optical films is formed among the optical films to integrate these optical films into an optical film assembly as shown in FIG. 2. Above description means that the adjacent optical films can be adhered temporarily or permanently after heating, pressing, or hot pressing the optical films so as to fix the relative positions of the optical films temporarily or permanently. In a preferred embodiment, the optical films are heated up around the Glass Transition Temperature so as to have stickiness on a plurality of surfaces of the optical films for making the adjacent optical films adhered each other temporarily or permanently.

Similarly, location and shape of the hot pressed part of the optical films can be dependent on the demands of the designs, such as the hot pressed part of the optical films in the corner, at the edge, or the periphery of the optical film assembly. In addition, the hot pressed part of the optical films can comprise a line, a dot, or any other shape.

The present invention also discloses a manufacturing apparatus for manufacturing the optical film assembly 20 as shown in FIG. 2 in accordance with the method shown in FIG. 4.

Please refer to FIG. 5, a perspective view of an embodiment of the manufacturing apparatus according to the present invention is shown. The manufacturing apparatus, adapted to partially adhere a first optical film 30 to a second optical film 31 includes a cutting platform 32, a first roller 33, a second roller 34, and a thermal cutter 35.

The cutting platform 32 can be an arbitrary platform used to bear weight while cutting the first optical film 30 and the second optical film 31 .

The first roller 33 is used to load the first optical film 30. As shown, the first optical film 30 can be coiled around the first roller 33. The first roller 33 transmits the first optical film 30 along a first path 331 above the cutting platform 32.

The second roller 34 is used to load the second optical film 31. As shown, the second optical film 31 can be coiled around the second roller 34. The second roller 34 transmits the second optical film 31 along a second path 341 above the cutting platform 32 and overlaps the first path 331. The intersecting angle between the first path 331 and the second path 341 depends on the demands. For example, if the first optical film 30 is a prism sheet and the second optical film 31 is also a prism sheet, the intersecting angle can be ninety degrees so as to make perpendicular the focusing directions of these two films.

The thermal cutter 35 is on the top of the cutting platform 32 which can move vertically for cutting the first optical film 30 and the second 31 optical film to a predetermined shape. Therefore, while the thermal cutter 35 cuts the first optical film 30 and the second 31 optical films, this thermal cutter 35 heats and cuts the optical films substantially at the same time, and makes the sections near the cut to be adhered mutually.

In a preferred embodiment, the manufacturing apparatus further includes a fixer 36. In addition, shape of the thermal cutter 35 can be formed as a hollow frame. The thermal cutter 35 can cut the first optical film 30 and the second optical film 31 to a predetermined shape. The location of the fixer 36 can be on top of the cutting platform 32 and inside the thermal cutter 35.

Before the thermal cutter proceeds to cut, the fixer 36 can move lower in advance to fix the first optical film 30 and the second optical film 31 on the cutting platform 32 by pressing in order to avoid the first optical film 30 and the second optical film 31 being warped.

After the thermal cutter 35 adheres and cuts the first optical film 30 and the second optical film 31 to form an optical film assembly, the optical film assembly and the thermal cutter 35 can be separated by pushing from the fixer 36.

FIG. 5 illustrates an example of a manufacturing apparatus which are applied to two pieces of optical films. If more than two pieces of optical films is involved to be cut simultaneously, a set of roller can be added. For example, in the case that three pieces of optical films are to be cut and hot pressed simultaneously, the manufacturing apparatus can have a third roller for transmitting a third optical film along a third path on the platform. The arrangement of the intersecting angles between the first path, the second path, and the third path can depend on the properties of the third optical film, the second optical film, and the first optical film.

Besides, in another embodiment, all the optical films to be cut can be properly loaded to the same roller.

In summary, the optical film assembly according to the present invention can be not only assembled into the backlight module directly but also can reduce the consuming of labor as well as time. Furthermore, the integrated films can provide a better structure strength to avoid possible single-layer warping while in being placed into the backlight module. Besides, because the optical film assembly is thicker than a typical single optical film, the optical film assembly is more convenient for robots to handle and thus the manufacturing automation can be feasible.

Also, the optical film assembly can be made by the above-mentioned method and the above-mentioned apparatus. By providing the present invention, the optical films are cut, hot pressed and adhered simultaneously in a single step to get the optical film assembly with the needful size and shape, which the assembly having plural films can be easily placed into the backlight module at a time. Upon such an arrangement, the procedures of cutting as well as the alignment process during manufacturing can be greatly simplified.

The embodiment above is to illustrate the invention in detail but not to give a specific embodiment. Any modification that doesn't exceed the essence of the invention should belong to this invention. Thus the invention should be safeguarded according to the claims as follows.

I claim:

1. An optical film assembly, comprising:
a plurality of optical films stacked layer by layer; and
a merging region which is formed by hot pressing the optical films.

2. The assembly of claim 1, wherein the merging region is located in a comer of the optical film assembly.

3. The assembly of claim 1, wherein the merging region is located at an edge of the optical film assembly.

4. The assembly of claim 1, wherein the merging region is located at the periphery of the optical film assembly.

5. The assembly of claim 1, wherein the merging region comprises a line.

6. The assembly of claim 1, wherein the merging region comprises a dot.

7. The assembly of claim 1, wherein the optical films are selected from a group consisting of diffusion sheet and prism sheet.

8. A method of manufacturing optical films, comprising:
superposing a plurality of optical films;
hot pressing part of the optical films so as to make the optical films adhered to each other; and
cutting the optical films.

9. The method of claim 8, wherein the optical films are selected from the group consisting of diffusion sheet and prism sheet.

10. The method of claim 8, wherein the steps of hot pressing and cutting the optical films are performed simultaneously.

11. The method of claim 10, wherein the steps of hot pressing and cutting the optical films are performed simultaneously by using a cutting tool which has enough temperature.

12. The method of claim 8, wherein the hot pressed part of the optical films is located in a corner of the optical film assembly.

13. The method of claim 8, wherein the hot pressed part of the optical films is located at an edge of the optical film assembly.

14. The method of claim 8, wherein the hot pressed part of the optical films is located at the periphery of the optical film assembly.

15. The method of claim 8, wherein the hot pressed part of the optical films comprises a line.

16. The method of claim 8, wherein shape of the hot pressed part of the optical films comprises a dot.

17. An apparatus, adapted to partially adhere a first optical film to a second optical film, comprising:
a cutting platform;
a first roller transmitting the first optical film along a first path above the cutting platform;
a second roller transmitting the second optical film along a second path above the cutting platform and overlapping the first path; and
a thermal cutter, located above the cutting platform, moving vertically for cutting the first optical film and the second optical film to a predetermined shape;
whereby the thermal cutter cuts and heats the first optical film and the second optical film substantially at the same time to make edges of the first optical film and the second optical film to be adhered.

18. The apparatus of claim 17, wherein the thermal cutter is a hollow frame and cuts the first optical film and the second optical film to a predetermined shape.

19. The apparatus of claim 18, wherein the apparatus further comprises a fixer which is disposed above the cutting platform and inside the thermal cutter, and which moves vertically for pressing and fixing the first optical film and the second optical film on the cutting platform.

20. The apparatus of claim 17, wherein the apparatus further comprises a fixer which is disposed above the cutting platform and moves vertically for pressing and fixing the first optical film and the second optical film on the cutting platform.

21. The apparatus of claim 17, wherein both the first optical film and the second optical film are selected from the group consisting of diffusion sheet and prism sheet.
